(19) United States
(12) Patent Application Publication
(10) Pub. No.: US 2005/0052544 A1
(43) Pub. Date: Mar. 10, 2005

(54) [PREVIEW SYSTEM OF A DIGITAL CAMERA]

(76) Inventor: Chih-Hua Tsai, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,414

(22) Filed: May 4, 2004

(30) Foreign Application Priority Data
Sep. 5, 2003 (TW) 92124561

(51) Int. Cl. H04N 5/262

(52) U.S. Cl. 348/223.1

(57) ABSTRACT

A preview system for a digital camera is provided. The preview system comprises an image capture apparatus, an image signal processor and a display device. The image capture apparatus detects from an actual photographic object to generate a first image signal. The image signal processor corrects the first image signal to generate a second image signal. The corrected second image signal is transmitted to the display device to provide a preview image. This invention discloses a simple image processor circuit. In addition, a less expensive and power-consuming multiple gray scale super-twisted nematic liquid crystal display (STN-LCD) instead of a color thin-film transistor liquid crystal display (TFT-LCD). Thus, the digital camera can operate for an extended period of time and an optical viewfinder can be omitted to reduce the size and the cost of the digital camera.

### CROSS REFERENCE TO RELATED APPLICATIONS

This application claims the priority benefit of Taiwan application serial no. 92124561, filed Sep. 05, 2003.

### BACKGROUND OF INVENTION

1. Field of the Invention

The present invention relates to a digital camera. More particularly, the present invention relates to the preview system of a digital camera.

2. Description of the Related Art

Cameras are often used for taking pictures for capturing images for work and/or daily life purposes. To ensure that the picture is taken as desired, a preview system is auxiliary for view finding. A conventional preview system includes an optical viewfinder disposed above a camera lens. According to the light source seen beyond the optical viewfinder, cameras can be classified into a single lens system and a dual lens system. In a dual lens system, the light travelling to the optical viewfinder is originated from an object via an observation lens instead of a camera lens thus leads to viewing aberration so that the observed image is slightly different from the actual image taken by the camera. A major improvement is obtained from a single lens camera because the light going to the optical viewfinder actually comes from the same lens that takes the picture.

With great advance in digital technologies, digital camera has gradually taken over a conventional camera. On a digital camera, an electronic preview system is configured for capturing images that is similar to the optical viewfinder of a conventional single lens camera. A conventional electronic preview system has a color thin film transistor liquid crystal display (TFT-LCD) for promptly displaying the image to be taken on the camera. Since a color TFT-LCD generally is considerable power consuming, a switch is often provided for the digital camera so that a user may opt to shut down the electronic preview system in order to extend endurance of the power. In addition, an optical viewfinder serving a function similar to a conventional dual lens camera is also provided. One major advantage of an optical viewfinder on a digital camera is because a simple mechanics is required and no electrical power is consumed. However, the optical viewfinder has a slightly different viewing angle from the camera lens so that close-up shot often leads to viewing aberration. In other words, the image seen from the optical viewfinder is slightly different from the picture actually taken.

Since the color TFT-LCD consumes considerable power, a digital camera often provides two previewing systems, an optical viewfinder and a color TFT-LCD, for user's choices. In order to accommodate a viewfinder, digital camera is limited by its size. For pursuing miniaturization in modern era, this conventional scheme is no longer satisfying. Moreover, color TFT-LCD has a relatively high production cost and the driving device complicated circuit wise. Consequently, the production cost of a digital camera remains high.

FIG. 1 is a block diagram showing the circuit layout of a TFT-LCD preview system inside a conventional digital camera. As shown in FIG. 1, an object image is scanned by an image capture apparatus 110 and is converted to a series of voltage signal 115. Thereafter, the voltage signal 115 is split by a color filter array (CFA) 120 into a trichromatic signal 125. Since ambiance illumination can be too bright or too dim, or intrinsic differences can exist in the nature of the light source (sunlight, tungsten lamp light, daylight lamp and so on), the light source needs to be white balanced. Hence, the trichromatic signal 125 is transmitted to a white balancing circuit 130 for light balancing. The image signal 135 is generated after white balancing. Since different color signals are often obtained from photographing the same object image with various image capture apparatus 110, a color correction procedure must be operated according to the properties of the image capture apparatus. Accordingly, the image signal 135 is sent to a color correction circuit 140 to adjust color performance so that an image signal 145 is produced. Furthermore, the voltage associated with the photosensing pixels in the image capture apparatus 110 is not linearly related to light transmittance of a TFT-LCD 190. Therefore, the image signal must undergo a Gamma correction to ensure brightness level of the captured images are correctly stored and displayed on the TFT-LCD 190. In other words, the image signal 145 is sent to a Gamma correction circuit 150 to produce corrected image signal 155. Thereafter, a color space transformation is carried out to transform the input image comprising the red (R), green (G) and blue (B) into luminance and chrominance, in terms of Y, Cb and Cr. Herein, Y represents luminance while Cb and Cr represents chrominance. The main reason for transforming trichromatics into luminance and chrominance is that human eyes are more sensitive to luminance than chrominance. Hence, the image signal 155 are processed via the color space transform circuit 160 where the R, G, B signal is transformed into Y, Cb, Cr signal to produce an image signal 165. The image signal 165 is processed via an edge enhancing circuit 170 to produce sharper image signal 175. Up to this stage, the image size is determined upon the image capture apparatus 110, which means the image size may be different from the display dimension of the TFT-LCD 190. To ensure that entire image is displayed on the TFT-LCD 180, a mathematical algorithm is performed to adjust the resolution of the image signal 175. A 2-D image scalar 180 processes the image signal 175, adjusts and outputs image signal 185 accordingly. Finally, the image signal 185 is introduced to the color TFT-LCD 190 so that an image is displayed correctly.

Accordingly, the preview system of a conventional digital camera involves in complicated image-processing ciruitry that consumes considerable power and raises cost thereof. The color TFT-LCD of the digital camera also consumes considerable power so that battery possesses lower endurance. Moreover, the components of the color TFT-LCD and the preview system are costly in production. Furthermore, an additional optical viewfinder has to be disposed for alternative view finding option due to power consuming property, which induces bulky camera body, less portability, and higher cost. Accordingly this electronic product is not satisfying as expected in innovation era.

### SUMMARY OF INVENTION

Accordingly, one objective of the present invention is to provide a preview system for a digital camera capable of reducing power consumption and extending operating time.

Another objective of the invention is to provide a preview system for a digital camera comprising simplified image-processing circuit inside the camera.

Yet another objective of this invention is to provide a preview system for a digital camera that requires no conventional optical viewfinder.

Yet another objective of this invention is to provide a preview system for a digital camera that lowers overall production cost and raises market competitiveness.

To achieve these and other advantages and in accordance with the purpose of the invention, as embodied and broadly described herein, the invention provides a preview system for a digital camera. The preview system comprises an image capture apparatus, an image signal processor and a display device. The image capture apparatus transforms the object image to a first image signal. The image signal processor briefly and effectively corrects the first image and generates a second image signal according to properties of image capture apparatus and power-saving device. The corrected second image signal is transmitted to the display device for preview purpose during photographing.

According to an embodiment of this invention, a super-twisted nematic liquid crystal display (STN-LCD) is adopted as a power-saving display. Where a multiple grayscale STN-LCD may be provided for better image quality. Alternatively, for lower cost purpose, a dual level black-and-white STN-LCD along with an appropriate dithering technique may be adopted to mimic display effects of a multiple gray scale STN-LCD.

According to an embodiment of this invention, the image signal processor comprises a Bayer data accumulator, a brightness scalar, a Gamma correction circuit, and a 2D-image scalar. The Bayer data accumulator receives a first image signal to generate a first temporary image signal. The brightness scalar is for receiving the first temporary signal to generate a second temporary image signal. Whereas the Gamma correction circuit receives the second temporary image signal to generate a third temporary image signal. Finally, the 2D-image scalar receives the third temporary image signal to generate a second image signal.

In this invention, a power-saving and low cost display device with simplified driving circuitry such as a multiple gray scale STN-LCD rather than a conventional color TFT-LCD is used. Hence, the display device is capable of extended operation time and eliminating optical viewfinder. In other word, size of a digital camera can be reduced and the production cost can be lowered.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the circuit of a TFT-LCD preview system of a conventional digital camera.

FIG. 2 is a block diagram showing a preview system of a digital camera according to an embodiment of this invention.

FIG. 3 is a block diagram showing an alternative preview system of a digital camera according to an embodiment of this invention.

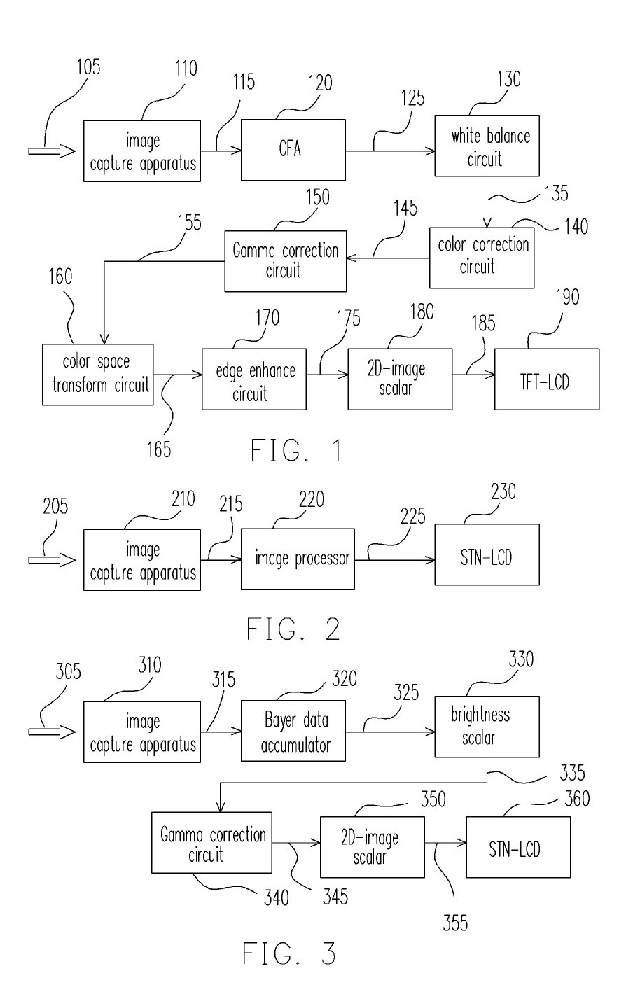

### DETAILED DESCRIPTION

Reference will now be made in detail to the embodiments of the present invention, examples of which are illustrated in the accompanying drawings. Wherever possible, the same reference numbers are used in the drawings and the description to refer to the same or like parts.

FIG. 2 is a block diagram showing a preview system of a digital camera according to an embodiment of this invention. As shown in FIG. 2, the preview system of the digital camera comprises an image capture apparatus 210, an image signal processor 220, and a super-twisted nematic liquid crystal display (STN-LCD) 230. First, an object image 205 is scanned to an image signal 215 via the image capture apparatus 210 according to optics principles. The image signal processor 220 performs a simple and effective image correction to the object image 205 according to the properties of the image capture apparatus 210 and the STN-LCD 230. Finally, according to the image signal 225, the STN-LCD 230 displays a preview picture of the image to be taken.

According to an embodiment of this invention, the aforementioned STN-LCD 230 can be a multiple gray scale STN-LCD to provide better image quality. Alternatively, to lower overall production cost, a dual level black-and-white STN-LCD along with an appropriate dithering technique may be mimic the display effects of a multiple gray scale STN-LCD.

FIG. 3 is a block diagram showing an alternative preview system of a digital camera according to an embodiment of this invention. As shown in FIG. 3, the preview system comprises a image capture apparatus 310, a Bayer data accumulator 320, a brightness scalar 330, a Gamma correction circuit 340, a 2D-image scalar 350, and an STN-LCD 360. Firstly, an object image 305 is scanned into image capture apparatus a series of image signal 315 with the image capture apparatus 310 based on optics principles. Since the image capture apparatus 310 progressively scans the Bayer color imaging array the image signal 315 in forms of series instead of in sequential pixels, the trichromatic s red (R), green (G) and blue (B) of a pixel of Bayer data has to be accumulated and averaged respectively. Referring to U.S. Pat. No. 3,971,065 for image processing method of Bayer data accumulator 320. Hence, the image signal 315 are processed by the Bayer data accumulator 320 so that red, green and blue signal of a pixel are accumulated and averaged respectively to generate an image signal 325 in sequential pixels. Furthermore, since luminance of photographing ambiance may be too bright or too dim, or since various light wavelengths are provided (light sources such as sunlight, tungsten lamp, daylight lamp, etc.), light source luminance has to be compensated for color abbreviation occurs. Thus, the image signal 325 is transmitted to the brightness scalar 330 where brightness level is adjusted to produce an image signal 335. temptemp Since the voltage associated with photosensing pixels in the image capture apparatus 310 is not linearly related to light transmittance (the twisted angle of the liquid crystal molecules) of the STN-LCD 360, a Gamma correction of the image signal 335 is required for storing and displaying correctly. That is, image luminance on STN-LCD 360 are corrected, with transmitting the image signal 335 to the Gamma correction circuit 340 to generate a corrected image signal 345. It is noted that the image size that is determined by the image capture apparatus 310 might not fit the dimension of the STN-LCD 360. In order to display a complete image on the STN-LCD 360, the image signal 345 is mathematically operated for resolution adjustment purpose, that is to adjust the image signal 345 with the 2D-image scalar 350. Thus an image signal 355 is generated. Finally, the image signal is introduced to the STN-LCD 360 for correct image display with preview function.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A preview system, for a digital camera, comprising:
an image capture apparatus, for generating a first image signal;
an image signal processor, for correcting the first image signal in order to generate a second image signal with gray scale characteristics; and
a display device, for providing an image preview function according to the second image signal.

2. The preview system of claim 1, wherein the display device comprises a super-twisted nematic liquid crystal display (STN-LCD).

3. The preview system of claim 2, wherein the super-twisted nematic liquid crystal display comprises a multiple gray scale super-twisted nematic liquid crystal display.

4. The preview system of claim 2, wherein the super-twisted nematic liquid crystal display comprises a black and white scale super-twisted nematic liquid crystal display.

5. The preview system of claim 4, wherein the black and white scale super-twisted nematic liquid crystal display employs dithering technique to mimic a multiple gray scale super-twisted nematic liquid crystal display.

6. The preview system of claim 1, wherein the image signal processor further comprises:
a Bayer data accumulator, for receiving the first image signal to generate a first temporary image signal;
a brightness scalar, for receiving the first temporary image signal to generate a second temporary signal;
a Gamma correction circuit, for receiving the second temporary image signal to generate a third temporary image signal; and
a 2D-image scalar, for receiving the third temporary image signal to generate the second image signal.
